(19) United States
(12) Patent Application Publication
(10) Pub. No.: US 2017/0163866 A1
(43) Pub. Date: Jun. 8, 2017

(54) Input System

(71) Applicant: Google Inc., Mountain View, CA (US)

(72) Inventors: Michael Patrick Johnson, Mountain View, CA (US); Bo Wu, Mountain View, CA (US); David Sparks, Mountain View, CA (US); Hayes Solos Raffle, Mountain View, CA (US)

(73) Assignee: Google Inc., Mountain View, CA (US)

(21) Appl. No.: 13/949,603

(22) Filed: Jul. 24, 2013

(51) Int. Cl. H04N 5/232

(52) U.S. Cl. CPC H04N 5/23203

(57) ABSTRACT

The present disclosure provides a computing device including an image-capture device and a control system. The control system may be configured to receive sensor data from one or more sensors, and analyze the sensor data to detect at least one image-capture signal. The control system may also be configured to cause the image-capture device to capture an image in response to detection of the at least one image-capture signal. The control system may also be configured to enable one or more speech commands relating to the image-capture device in response to capturing the image. The control system may also be configured to receive one or more verbal inputs corresponding to the one or more enabled speech commands. The control system may also be configured to perform an image-capture function corresponding to the one or more verbal inputs.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a graphic display close enough to a wearer's (or user's) eye(s) such that the displayed image appears as a normal-sized image, such as might be displayed on a traditional image display device. The relevant technology may be referred to as “near-eye displays.”

Wearable computing devices with near-eye displays may also be referred to as “head-mountable displays” (HMDs), “head-mounted displays,” “head-mounted devices,” or “head-mountable devices.” A head-mountable display places a graphic display or displays close to one or both eyes of a wearer. To generate the images on a display, a computer processing system may be used. Such displays may occupy a wearer's entire field of view, or only occupy part of wearer's field of view. Further, head-mounted displays may vary in size, taking a smaller form such as a glasses-style display or a larger form such as a helmet, for example.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming. Many other applications are also possible.

### SUMMARY

In one embodiment, the present disclosure provides a computing device including an image-capture device and a control system. The control system may be configured to receive sensor data from one or more sensors, and analyze the sensor data to detect at least one image-capture signal. The control system may also be configured to cause the image-capture device to capture an image in response to detection of the at least one image-capture signal. The control system may also be configured to enable one or more speech commands relating to the image-capture device in response to capturing the image. The control system may also be configured to receive one or more verbal inputs corresponding to the one or more enabled speech commands. The control system may also be configured to perform an image-capture function corresponding to the one or more verbal inputs.

In another embodiment, the present disclosure provides a computer implemented method. The method may include receiving sensor data from one or more sensors associated with a computing device. The computing device may include an image-capture device. The method may also include analyzing the sensor data to detect at least one image-capture signal. The method may also include causing the image-capture device to capture an image in response to detection of the at least one image-capture signal. The method may also include enabling one or more speech commands relating to the image-capture device in response to capturing the image. The method may also include receiving one or more verbal inputs corresponding to the one or more enabled speech commands. The method may also include performing an image-capture function corresponding to the one or more verbal inputs.

In yet another embodiment, the present disclosure provides a non-transitory computer readable medium having stored therein instructions executable by a computing device to cause the computing device to perform functions. The functions may include receiving sensor data from one or more sensors associated with a computing device. The computing device may include an image-capture device. The functions may also include analyzing the sensor data to detect at least one image-capture signal. The functions may also include causing the image-capture device to capture an image in response to detection of the at least one image-capture signal. The functions may also include enabling one or more speech commands relating to the image-capture device in response to capturing the image. The functions may also include receiving one or more verbal inputs corresponding to the one or more enabled speech commands. The functions may also include performing an image-capture function corresponding to the one or more verbal inputs.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 shows screen views of a user-interface during a transition between two interface modes, according to an example embodiment.

FIG. 2A illustrates a wearable computing system according to an example embodiment.

FIG. 2B illustrates an alternate view of the wearable computing device illustrated in FIG. 2A.

FIG. 2C illustrates another wearable computing system according to an example embodiment.

FIG. 2D illustrates another wearable computing system according to an example embodiment.

FIGS. 2E to 2G are simplified illustrations of the wearable computing system shown in FIG. 1D, being worn by a wearer.

FIG. 3A is a simplified block diagram of a computing device according to an example embodiment.

FIG. 3B shows a projection of an image by a head-mountable device, according to an example embodiment.

FIGS. 4A, 4B and 4C are flow charts illustrating methods, according to example embodiments.

FIGS. 5A and 5B illustrate views of a user-interface, according to example embodiments.

FIG. 6 depicts a computer-readable medium configured according to an example embodiment.

### DETAILED DESCRIPTION

Example methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

### I. OVERVIEW

A head-mountable device (HMD) may be configured to provide a voice interface, and as such, may be configured to listen for commands that are spoken by the wearer. Herein spoken commands may be referred to interchangeably as either “voice commands” or “speech commands.”

When an HMD enables speech commands, the HMD may continuously listen for speech, so that a user can readily use the speech commands to interact with the HMD. Some of these speech commands may relate to photography, or more generally to an image-capture device (e.g., a camera) of the HMD. It may be desirable to implement an image-capture signal, such as a wink or other eye gesture, that can be performed to indicate to the HMD that the user is about to provide a speech command related to the imaging functionality. In particular, by waiting until such an image-capture signal is detected before enabling such speech commands, an HMD may reduce the occurrence of false-positive. In other words, the HMD may reduce instances where the HMD incorrectly interprets speech as including a particular speech command, and thus takes an undesired action. As a further advantage, the HMD may also conserve battery power since the HMD does not have to listen for speech commands continually.

In operation, the HMD may include one or more sensors configured to detect the image-capture signal, such as a wink or other eye gesture. When the HMD detects the image-capture signal, a speech recognition system may be optimized to recognize a small set of words and/or phrases. In one example, this may include a photo-related “hotword” model that may be loaded into the HMD. The photo-related “hotword” model may be configured to listen for a subset of speech commands that are specific to photography and/or image-capture device settings.

In one embodiment, an eye gesture may enable the HMD to both take a photo and enable imaging related commands. For example, a user may wink, and the HMD may concurrently take a photo and enable various imaging related commands. The imaging related commands may allow a user to alter or share the image just captured (e.g., by processing the image, sharing the image on a social network, saving the image, etc.). In another example, the imaging related commands may allow a user to record a video, a panorama, and/or a time-lapse of multiple photographs over a period of time. If the command is to record a video, the image captured in response to wink may be deleted when the video recording begins. In another example, the image captured in response to the wink may be used as a thumbnail for the video recording.

If the HMD detects an image-capture signal and a photo is taken, the HMD may load a photo-related “hotword” model and listen for certain voice commands. For example, the HMD may listen for the voice command “Record” to record a video. In another example, the HMD may listen for the voice command “Time-lapse” to take a photo every M seconds. Further, the HMD may listen for the voice command “Panorama” to record a panorama where the user turns around and captures a 360-degree image. Other example image-capture functions are possible as well.

In a further aspect, other voice commands may be applied to “the photo just taken”. In one example, the photo-related “hotword” model may listen for various image processing filter commands, such as “Black and White,” “Posterize,” and “Sepia” as examples. Such commands would apply an image filter to the photo just taken by the image-capture device in response to the image-capture signal. Additionally, the photo-related “hotword” model may listen for a sharing command, such as “Share with Bob” which could be used to share the photo just taken with any contact. A potential flow for this process may include: Wink (takes picture)+“Black and White”+“Share with Bob”.

In a further aspect, a time-out process may be implemented in order to disable the enabled speech commands if at least one of the enabled speech commands is not detected within a predetermined period of time after detection of the image-capture signal. For example, in the implementation described above, a time-out process may be implemented when the image-capture signal is detected. As such, when the HMD detects the image-capture signal, the HMD may start a timer. Then, if the HMD does not detect a speech command within five seconds, for example, then the HMD may disable such speech commands, and require the image-capture signal in order to re-enable those speech commands.

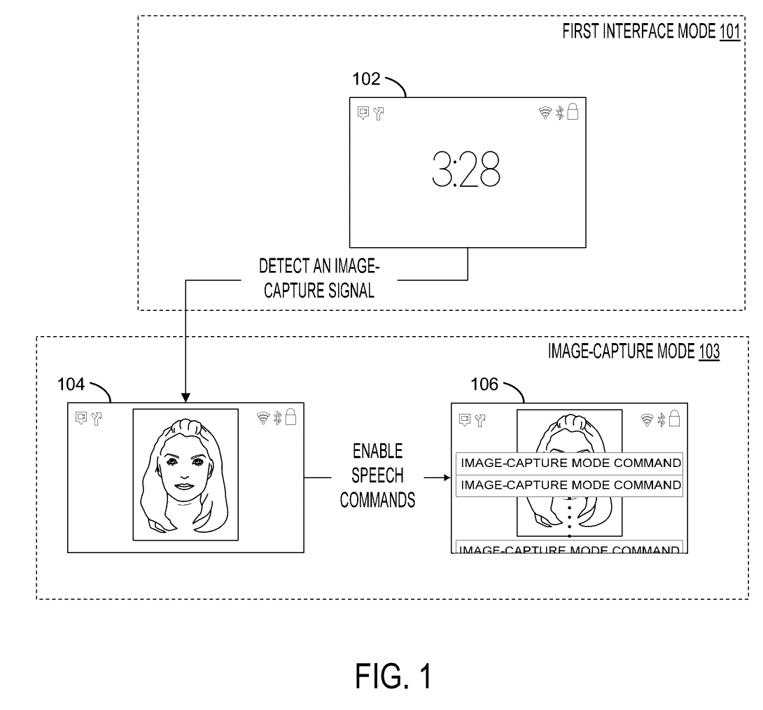

For example, FIG. 1 shows screen views of a user interface (UI) during a transition between two interface modes, according to an example embodiment.

More specifically, an HMD may operate in a first interface mode 101, where one or more image-capture mode speech commands can be enabled by detecting an image-capture signal. In one example, the image-capture signal may comprise sensor data that is indicative of an eye gesture, such as a wink for example. In another example, the image-capture signal may comprise sensor data that is indicative of an interaction with a button interface. Other examples are possible as well. If the HMD detects the image-capture signal while in the first interface mode 101, the HMD may capture an image, as shown in screen view 104. The HMD may then enable one or more image-capture mode commands (e.g., speech commands), and display visual cues that indicate the enabled image-capture mode commands, as shown in screen view 106.

To provide an example, the first interface mode 101 may provide an interface for a home screen, which provides a launching point for a user to access a number of frequently-used features. Accordingly, when the user speaks a command to access a different feature, such as an image-capture device feature, the HMD may switch to the interface mode that provides an interface for the different feature.

More specifically, when the HMD switches to a different aspect of its UI for which one or more image-capture mode speech commands are supported, the HMD may switch to the image-capture mode 103. When the HMD switches to the image-capture mode 103, the HMD may disable any speech commands that were previously enabled, and listen only for the image-capture mode commands (e.g., by loading an image-capture mode hotword process).

Many implementations of the image-capture mode commands are possible. For example, the HMD may listen for the voice command “Record” to record a video. In another example, the HMD may listen for the voice command “Time-lapse” to take a photo every M seconds. Further, the HMD may listen for the voice command “Panorama” to record a panorama where the user turns around and captures a 360-degree image. In another example, the image-capture mode commands may include various image processing filter commands, such as “Black and White,” and “Sepia” as examples. Additionally, the image-capture mode commands may include a sharing command, such as “Share with X” which could be used to share the photo just taken via a communication link. Other implementations are also possible.

### II. EXAMPLE WEARABLE COMPUTING DEVICES

Systems and devices in which example embodiments may be implemented will now be described in greater detail. In general, an example system may be implemented in or may take the form of a wearable computer (also referred to as a wearable computing device). In an example embodiment, a wearable computer takes the form of or includes a head-mountable device (HMD).

An example system may also be implemented in or take the form of other devices that support speech commands, such as a mobile phone, tablet computer, laptop computer, or desktop computer, among other possibilities. Further, an example system may take the form of non-transitory computer readable medium, which has program instructions stored thereon that are executable by at a processor to provide the functionality described herein. An example system may also take the form of a device such as a wearable computer or mobile phone, or a subsystem of such a device, which includes such a non-transitory computer readable medium having such program instructions stored thereon.

An HMD may generally be any display device that is capable of being worn on the head and places a display in front of one or both eyes of the wearer. An HMD may take various forms such as a helmet or eyeglasses. As such, references to “eyeglasses” or a “glasses-style” HMD should be understood to refer to an HMD that has a glasses-like frame so that it can be worn on the head. Further, example embodiments may be implemented by or in association with an HMD with a single display or with two displays, which may be referred to as a “monocular” HMD or a “binocular” HMD, respectively.

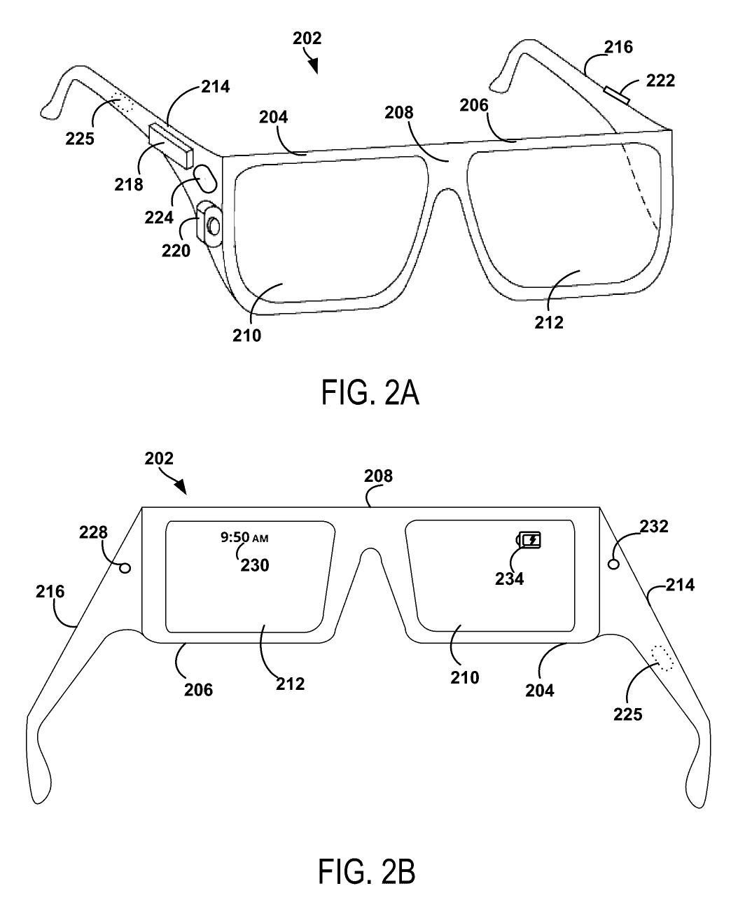

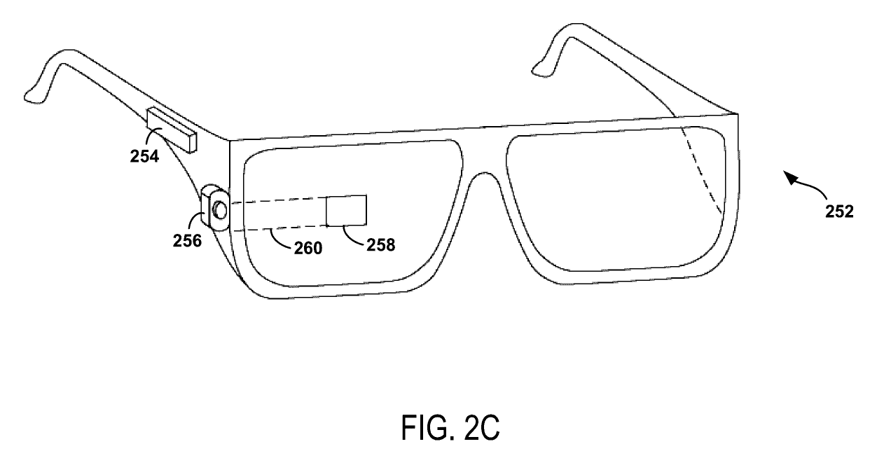

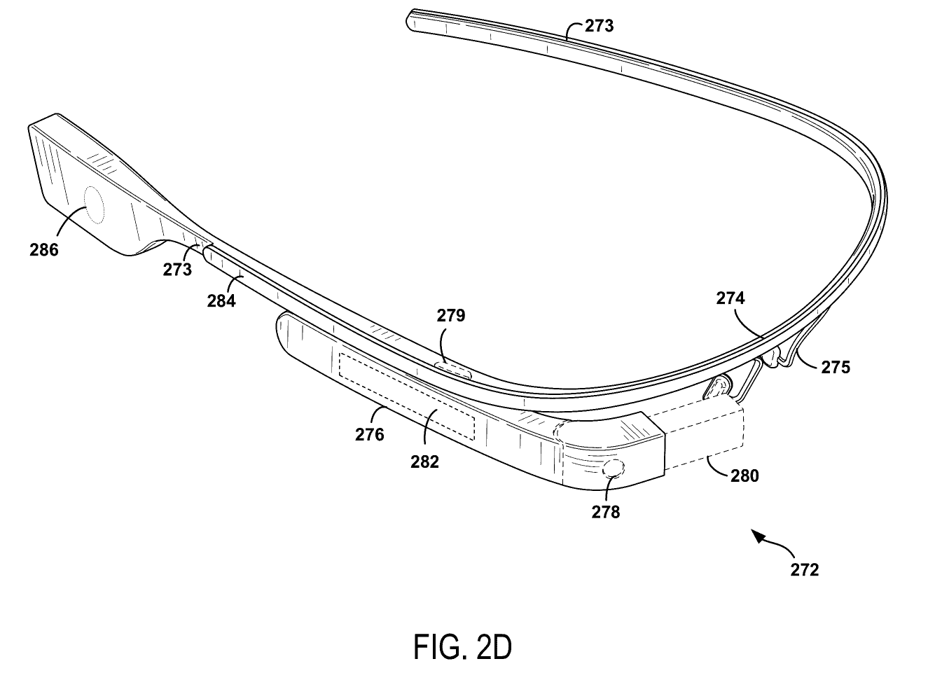

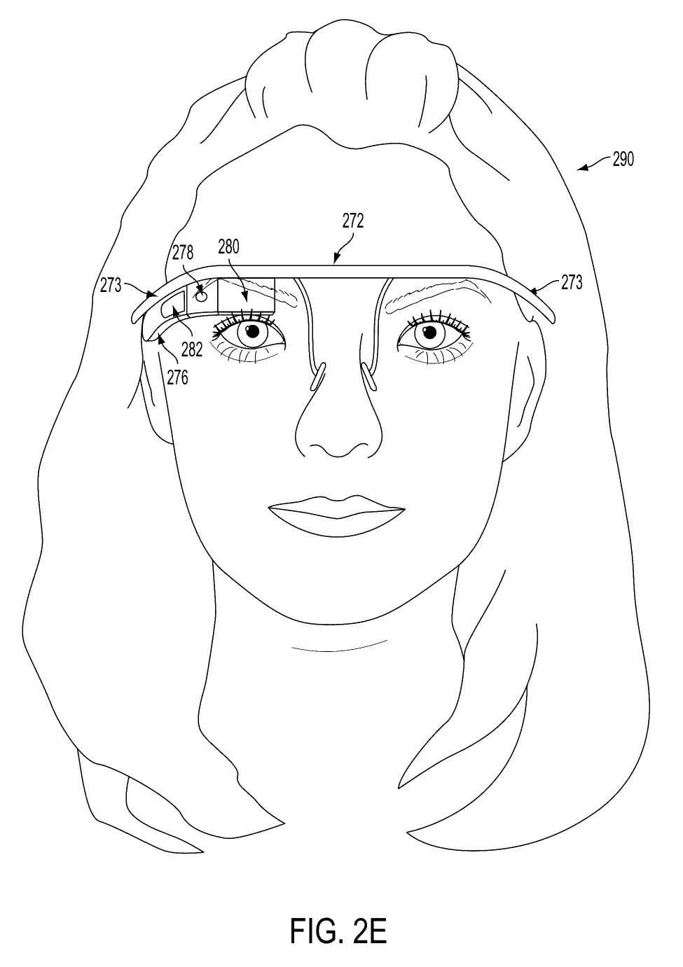

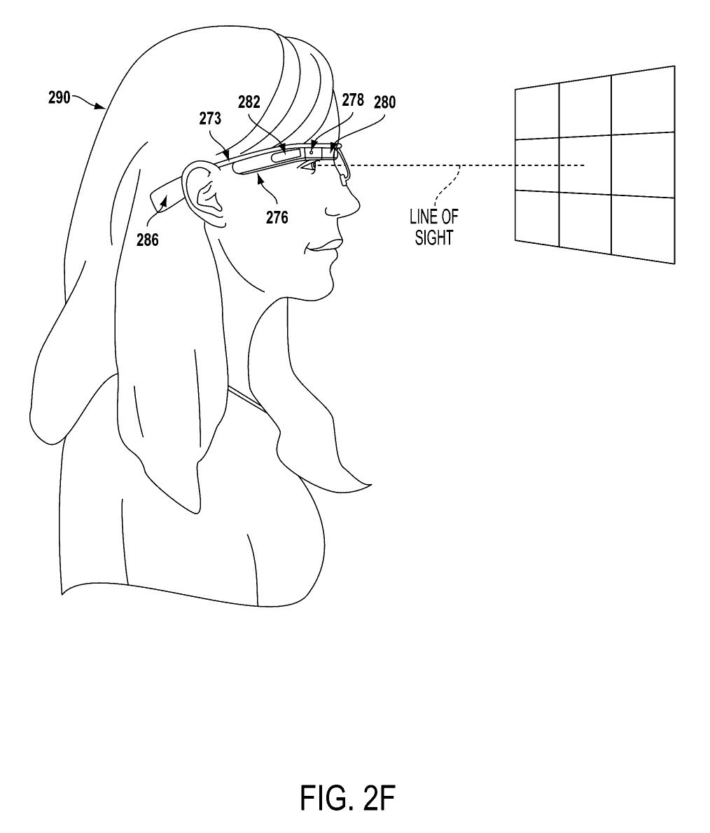

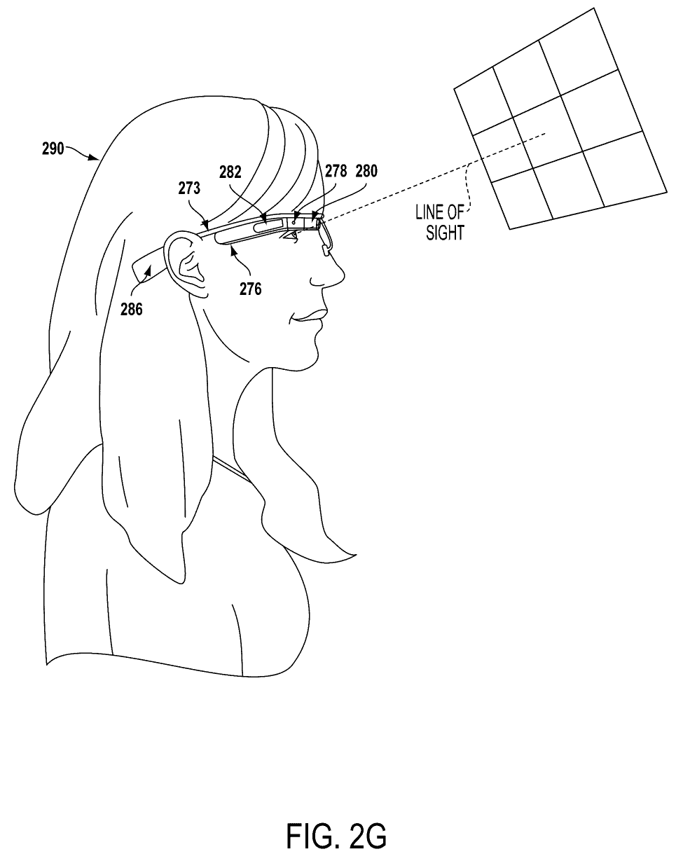

FIG. 2A illustrates a wearable computing system according to an example embodiment. In FIG. 2A, the wearable computing system takes the form of a head-mountable device (HMD) 202 (which may also be referred to as a head-mounted display). It should be understood, however, that example systems and devices may take the form of or be implemented within or in association with other types of devices, without departing from the scope of the invention. As illustrated in FIG. 2A, the HMD 202 includes frame elements including lens-frames 204, 206 and a center frame support 208, lens elements 210, 212, and extending side-arms 214, 216. The center frame support 208 and the extending side-arms 214, 216 are configured to secure the HMD 202 to a user's face via a user's nose and ears, respectively.

Each of the frame elements 204, 206, and 208 and the extending side-arms 214, 216 may be formed of a solid structure of plastic and/or metal, or may be formed of a hollow structure of similar material so as to allow wiring and component interconnects to be internally routed through the HMD 202. Other materials may be possible as well.

One or more of each of the lens elements 210, 212 may be formed of any material that can suitably display a projected image or graphic. Each of the lens elements 210, 212 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 214, 216 may each be projections that extend away from the lens-frames 204, 206, respectively, and may be positioned behind a user's ears to secure the HMD 202 to the user. The extending side-arms 214, 216 may further secure the HMD 202 to the user by extending around a rear portion of the user's head. Additionally or alternatively, for example, the HMD 202 may connect to or be affixed within a head-mounted helmet structure. Other configurations for an HMD are also possible.

The HMD 202 may also include an on-board computing system 218, an image capture device 220, a sensor 222, and a finger-operable touch pad 224. The on-board computing system 218 is shown to be positioned on the extending side-arm 214 of the HMD 202; however, the on-board computing system 218 may be provided on other parts of the HMD 202 or may be positioned remote from the HMD 202 (e.g., the on-board computing system 218 could be wire- or wirelessly-connected to the HMD 202). The on-board computing system 218 may include a processor and memory, for example. The on-board computing system 218 may be configured to receive and analyze data from the image capture device 220 and the finger-operable touch pad 224 (and possibly from other sensory devices, user interfaces, or both) and generate images for output by the lens elements 210 and 212.

The image capture device 220 may be, for example, a camera that is configured to capture still images and/or to capture video. In the illustrated configuration, image capture device 220 is positioned on the extending side-arm 214 of the HMD 202; however, the image capture device 220 may be provided on other parts of the HMD 202. The image capture device 220 may be configured to capture images at various resolutions or at different frame rates. Many image capture devices with a small form-factor, such as the cameras used in mobile phones or webcams, for example, may be incorporated into an example of the HMD 202.

Further, although FIG. 2A illustrates one image capture device 220, more image capture device may be used, and each may be configured to capture the same view, or to capture different views. For example, the image capture device 220 may be forward facing to capture at least a portion of the real-world view perceived by the user. This forward facing image captured by the image capture device 220 may then be used to generate an augmented reality where computer generated images appear to interact with or overlay the real-world view perceived by the user.

The sensor 222 is shown on the extending side-arm 216 of the HMD 202; however, the sensor 222 may be positioned on other parts of the HMD 202. For illustrative purposes, only one sensor 222 is shown. However, in an example embodiment, the HMD 202 may include multiple sensors. For example, an HMD 202 may include sensors 202 such as one or more gyroscopes, one or more accelerometers, one or more magnetometers, one or more light sensors, one or more infrared sensors, and/or one or more microphones. Other sensing devices may be included in addition or in the alternative to the sensors that are specifically identified herein.

The finger-operable touch pad 224 is shown on the extending side-arm 214 of the HMD 202. However, the finger-operable touch pad 224 may be positioned on other parts of the HMD 202. Also, more than one finger-operable touch pad may be present on the HMD 202. The finger-operable touch pad 224 may be used by a user to input commands. The finger-operable touch pad 224 may sense at least one of a pressure, position and/or a movement of one or more fingers via capacitive sensing, resistance sensing, or a surface acoustic wave process, among other possibilities. The finger-operable touch pad 224 may be capable of sensing movement of one or more fingers simultaneously, in addition to sensing movement in a direction parallel or planar to the pad surface, in a direction normal to the pad surface, or both, and may also be capable of sensing a level of pressure applied to the touch pad surface. In some embodiments, the finger-operable touch pad 224 may be formed of one or more translucent or transparent insulating layers and one or more translucent or transparent conducting layers. Edges of the finger-operable touch pad 224 may be formed to have a raised, indented, or roughened surface, so as to provide tactile feedback to a user when the user's finger reaches the edge, or other area, of the finger-operable touch pad 224. If more than one finger-operable touch pad is present, each finger-operable touch pad may be operated independently, and may provide a different function.

In a further aspect, HMD 202 may be configured to receive user input in various ways, in addition or in the alternative to user input received via finger-operable touch pad 224. For example, on-board computing system 218 may implement a speech-to-text process and utilize a syntax that maps certain spoken commands to certain actions. In addition, HMD 202 may include one or more microphones via which a wearer's speech may be captured. Configured as such, HMD 202 may be operable to detect spoken commands and carry out various computing functions that correspond to the spoken commands.

As another example, HMD 202 may interpret certain head-movements as user input. For example, when HMD 202 is worn, HMD 202 may use one or more gyroscopes and/or one or more accelerometers to detect head movement. The HMD 202 may then interpret certain head-movements as being user input, such as nodding, or looking up, down, left, or right. An HMD 202 could also pan or scroll through graphics in a display according to movement. Other types of actions may also be mapped to head movement.

As yet another example, HMD 202 may interpret certain gestures (e.g., by a wearer's hand or hands) as user input. For example, HMD 202 may capture hand movements by analyzing image data from image capture device 220, and initiate actions that are defined as corresponding to certain hand movements.

As a further example, HMD 202 may interpret eye movement as user input. In particular, HMD 202 may include one or more inward-facing image capture devices and/or one or more other inward-facing sensors (not shown) that may be used to track eye movements and/or determine the direction of a wearer's gaze. As such, certain eye movements may be mapped to certain actions. For example, certain actions may be defined as corresponding to movement of the eye in a certain direction, a blink, and/or a wink, among other possibilities.

HMD 202 also includes a speaker 225 for generating audio output. In one example, the speaker could be in the form of a bone conduction speaker, also referred to as a bone conduction transducer (BCT). Speaker 225 may be, for example, a vibration transducer or an electroacoustic transducer that produces sound in response to an electrical audio signal input. The frame of HMD 202 may be designed such that when a user wears HMD 202, the speaker 225 contacts the wearer. Alternatively, speaker 225 may be embedded within the frame of HMD 202 and positioned such that, when the HMD 202 is worn, speaker 225 vibrates a portion of the frame that contacts the wearer. In either case, HMD 202 may be configured to send an audio signal to speaker 225, so that vibration of the speaker may be directly or indirectly transferred to the bone structure of the wearer. When the vibrations travel through the bone structure to the bones in the middle ear of the wearer, the wearer can interpret the vibrations provided by BCT 225 as sounds.

Various types of bone-conduction transducers (BCTs) may be implemented, depending upon the particular implementation. Generally, any component that is arranged to vibrate the HMD 202 may be incorporated as a vibration transducer. Yet further it should be understood that an HMD 202 may include a single speaker 225 or multiple speakers. In addition, the location(s) of speaker(s) on the HMD may vary, depending upon the implementation. For example, a speaker may be located proximate to a wearer's temple (as shown), behind the wearer's ear, proximate to the wearer's nose, and/or at any other location where the speaker 225 can vibrate the wearer's bone structure.

FIG. 2B illustrates an alternate view of the wearable computing device illustrated in FIG. 2A. As shown in FIG. 2B, the lens elements 210, 212 may act as display elements. The HMD 202 may include a first projector 228 coupled to an inside surface of the extending side-arm 216 and configured to project a display 230 onto an inside surface of the lens element 212. Additionally or alternatively, a second projector 232 may be coupled to an inside surface of the extending side-arm 214 and configured to project a display 234 onto an inside surface of the lens element 210.

The lens elements 210, 212 may act as a combiner in a light projection system and may include a coating that reflects the light projected onto them from the projectors 228, 232. In some embodiments, a reflective coating may not be used (e.g., when the projectors 228, 232 are scanning laser devices).

In alternative embodiments, other types of display elements may also be used. For example, the lens elements 210, 212 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 204, 206 for driving such a matrix display. Alternatively or additionally, a laser or LED source and scanning system could be used to draw a raster display directly onto the retina of one or more of the user's eyes. Other possibilities exist as well.

FIG. 2C illustrates another wearable computing system according to an example embodiment, which takes the form of an HMD 252. The HMD 252 may include frame elements and side-arms such as those described with respect to FIGS. 2A and 2B. The HMD 252 may additionally include an on-board computing system 254 and an image capture device 256, such as those described with respect to FIGS. 2A and 2B. The image capture device 256 is shown mounted on a frame of the HMD 252. However, the image capture device 256 may be mounted at other positions as well.

As shown in FIG. 2C, the HMD 252 may include a single display 258 which may be coupled to the device. The display 258 may be formed on one of the lens elements of the HMD 252, such as a lens element described with respect to FIGS. 2A and 2B, and may be configured to overlay computer-generated graphics in the user's view of the physical world. The display 258 is shown to be provided in a center of a lens of the HMD 252, however, the display 258 may be provided in other positions, such as for example towards either the upper or lower portions of the wearer's field of view. The display 258 is controllable via the computing system 254 that is coupled to the display 258 via an optical waveguide 260.

FIG. 2D illustrates another wearable computing system according to an example embodiment, which takes the form of a monocular HMD 272. The HMD 272 may include side-arms 273, a center frame support 274, and a bridge portion with nosepiece 275. In the example shown in FIG. 2D, the center frame support 274 connects the side-arms 273. The HMD 272 does not include lens-frames containing lens elements. The HMD 272 may additionally include a component housing 276, which may include an on-board computing system (not shown), an image capture device 278, and a button 279 for operating the image capture device 278 (and/or usable for other purposes). Component housing 276 may also include other electrical components and/or may be electrically connected to electrical components at other locations within or on the HMD. HMD 272 also includes a BCT 286.

The HMD 272 may include a single display 280, which may be coupled to one of the side-arms 273 via the component housing 276. In an example embodiment, the display 280 may be a see-through display, which is made of glass and/or another transparent or translucent material, such that the wearer can see their environment through the display 280. Further, the component housing 276 may include the light sources (not shown) for the display 280 and/or optical elements (not shown) to direct light from the light sources to the display 280. As such, display 280 may include optical features that direct light that is generated by such light sources towards the wearer's eye, when HMD 272 is being worn.

In a further aspect, HMD 272 may include a sliding feature 284, which may be used to adjust the length of the side-arms 273. Thus, sliding feature 284 may be used to adjust the fit of HMD 272. Further, an HMD may include other features that allow a wearer to adjust the fit of the HMD, without departing from the scope of the invention.

FIGS. 2E to 2G are simplified illustrations of the HMD 272 shown in FIG. 2D, being worn by a wearer 290. As shown in FIG. 2F, when HMD 272 is worn, BCT 286 is arranged such that when HMD 272 is worn, BCT 286 is located behind the wearer's ear. As such, BCT 286 is not visible from the perspective shown in FIG. 2E.

In the illustrated example, the display 280 may be arranged such that when HMD 272 is worn, display 280 is positioned in front of or proximate to a user's eye when the HMD 272 is worn by a user. For example, display 280 may be positioned below the center frame support and above the center of the wearer's eye, as shown in FIG. 2E. Further, in the illustrated configuration, display 280 may be offset from the center of the wearer's eye (e.g., so that the center of display 280 is positioned to the right and above of the center of the wearer's eye, from the wearer's perspective).

Configured as shown in FIGS. 2E to 2G, display 280 may be located in the periphery of the field of view of the wearer 290, when HMD 272 is worn. Thus, as shown by FIG. 2F, when the wearer 290 looks forward, the wearer 290 may see the display 280 with their peripheral vision. As a result, display 280 may be outside the central portion of the wearer's field of view when their eye is facing forward, as it commonly is for many day-to-day activities. Such positioning can facilitate unobstructed eye-to-eye conversations with others, as well as generally providing unobstructed viewing and perception of the world within the central portion of the wearer's field of view. Further, when the display 280 is located as shown, the wearer 290 may view the display 280 by, e.g., looking up with their eyes only (possibly without moving their head). This is illustrated as shown in FIG. 2G, where the wearer has moved their eyes to look up and align their line of sight with display 280. A wearer might also use the display by tilting their head down and aligning their eye with the display 280.

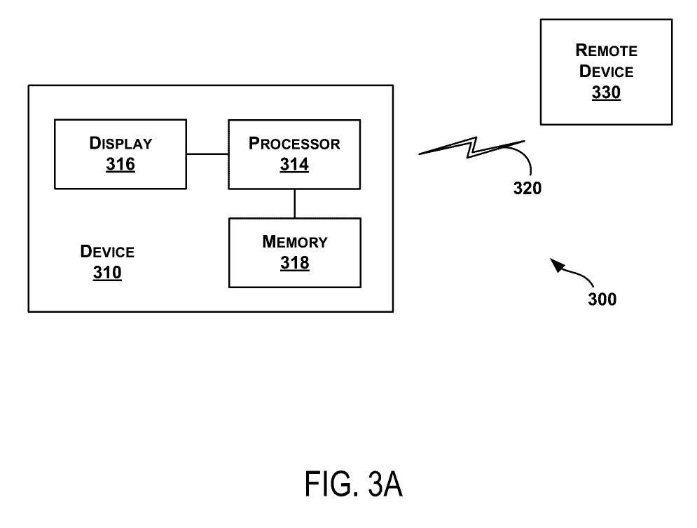

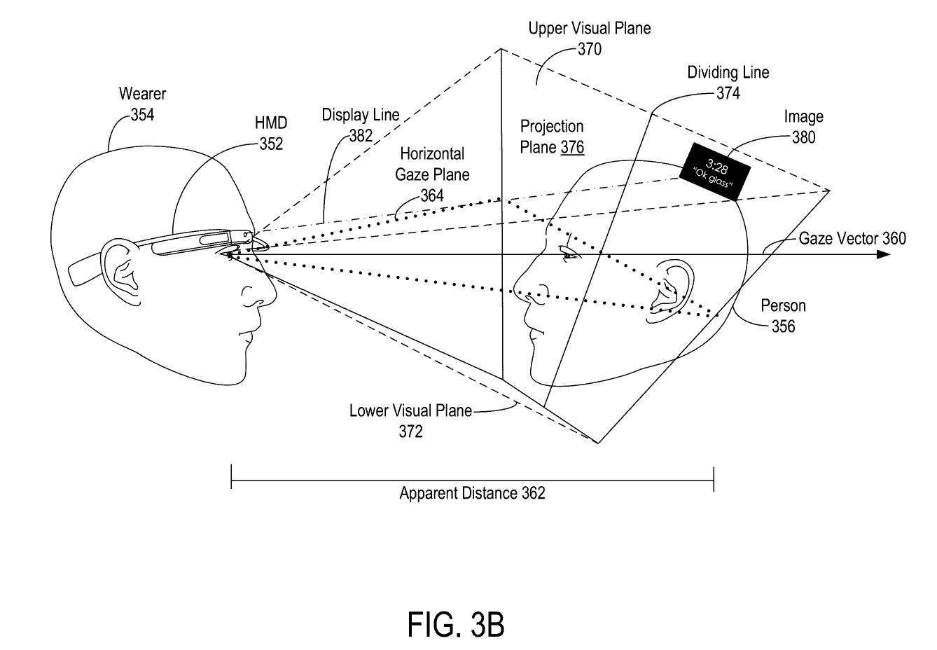

FIG. 3A is a simplified block diagram a computing device 310 according to an example embodiment. In an example embodiment, device 310 communicates using a communication link 320 (e.g., a wired or wireless connection) to a remote device 330. The device 310 may be any type of device that can receive data and display information corresponding to or associated with the data. For example, the device 310 may take the form of or include a head-mountable display, such as the head-mounted devices 202, 252, or 272 that are described with reference to FIGS. 2A to 2G.

The device 310 may include a processor 314 and a display 316. The display 316 may be, for example, an optical see-through display, an optical see-around display, or a video see-through display. The processor 314 may receive data from the remote device 330, and configure the data for display on the display 316. The processor 314 may be any type of processor, such as a micro-processor or a digital signal processor, for example.

The device 310 may further include on-board data storage, such as memory 318 coupled to the processor 314. The memory 318 may store software that can be accessed and executed by the processor 314, for example.

The remote device 330 may be any type of computing device or transmitter including a laptop computer, a mobile telephone, head-mountable display, tablet computing device, etc., that is configured to transmit data to the device 310. The remote device 330 and the device 310 may contain hardware to enable the communication link 320, such as processors, transmitters, receivers, antennas, etc.

Further, remote device 330 may take the form of or be implemented in a computing system that is in communication with and configured to perform functions on behalf of client device, such as computing device 310. Such a remote device 330 may receive data from another computing device 310 (e.g., an HMD 202, 252, or 272 or a mobile phone), perform certain processing functions on behalf of the device 310, and then send the resulting data back to device 310. This functionality may be referred to as “cloud” computing.

In FIG. 3A, the communication link 320 is illustrated as a wireless connection; however, wired connections may also be used. For example, the communication link 320 may be a wired serial bus such as a universal serial bus or a parallel bus. A wired connection may be a proprietary connection as well. The communication link 320 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 330 may be accessible via the Internet and may include a computing cluster associated with a particular web service (e.g., social-networking, photo sharing, address book, etc.).

FIG. 3B shows an example projection of UI elements described herein via an image 380 by an example head-mountable device (HMD) 352, according to an example embodiment. Other configurations of an HMD may be also be used to present the UI described herein via image 380. FIG. 3B shows wearer 354 of HMD 352 looking at an eye of person 356. As such, wearer 354's gaze, or direction of viewing, is along gaze vector 360. A horizontal plane, such as horizontal gaze plane 364 can then be used to divide space into three portions: space above horizontal gaze plane 364, space in horizontal gaze plane 364, and space below horizontal gaze plane 364. In the context of projection plane 376, horizontal gaze plane 360 appears as a line that divides projection plane into a subplane above the line of horizontal gaze plane 360, a subplane a subspace below the line of horizontal gaze plane 360, and the line where horizontal gaze plane 360 intersects projection plane 376. In FIG. 3B, horizontal gaze plane 364 is shown using dotted lines.

Additionally, a dividing plane, indicated using dividing line 374 can be drawn to separate space into three other portions: space to the left of the dividing plane, space on the dividing plane, and space to right of the dividing plane. In the context of projection plane 376, the dividing plane intersects projection plane 376 at dividing line 374. Thus the dividing plane divides projection plane into: a subplane to the left of dividing line 374, a subplane to the right of dividing line 374, and dividing line 374. In FIG. 3B, dividing line 374 is shown as a solid line.

Humans, such as wearer 354, when gazing in a gaze direction, may have limits on what objects can be seen above and below the gaze direction. FIG. 3B shows the upper visual plane 370 as the uppermost plane that wearer 354 can see while gazing along gaze vector 360, and shows lower visual plane 372 as the lowermost plane that wearer 354 can see while gazing along gaze vector 360. In FIG. 3B, upper visual plane 370 and lower visual plane 372 are shown using dashed lines.

The HMD can project an image for view by wearer 354 at some apparent distance 362 along display line 382, which is shown as a dotted and dashed line in FIG. 3B. For example, apparent distance 362 can be 1 meter, four feet, infinity, or some other distance. That is, HMD 352 can generate a display, such as image 380, which appears to be at the apparent distance 362 from the eye of wearer 354 and in projection plane 376. In this example, image 380 is shown between horizontal gaze plane 364 and upper visual plane 370; that is image 380 is projected above gaze vector 360. In this example, image 380 is also projected to the right of dividing line 374. As image 380 is projected above and to the right of gaze vector 360, wearer 354 can look at person 356 without image 380 obscuring their general view. In one example, the display element of the HMD 352 is translucent when not active (i.e. when image 380 is not being displayed), and so the wearer 354 can perceive objects in the real world along the vector of display line 382.

Other example locations for displaying image 380 can be used to permit wearer 354 to look along gaze vector 360 without obscuring the view of objects along the gaze vector. For example, in some embodiments, image 380 can be projected above horizontal gaze plane 364 near and/or just above upper visual plane 370 to keep image 380 from obscuring most of wearer 354's view. Then, when wearer 354 wants to view image 380, wearer 354 can move their eyes such that their gaze is directly toward image 380.

### III. EXAMPLE METHODS

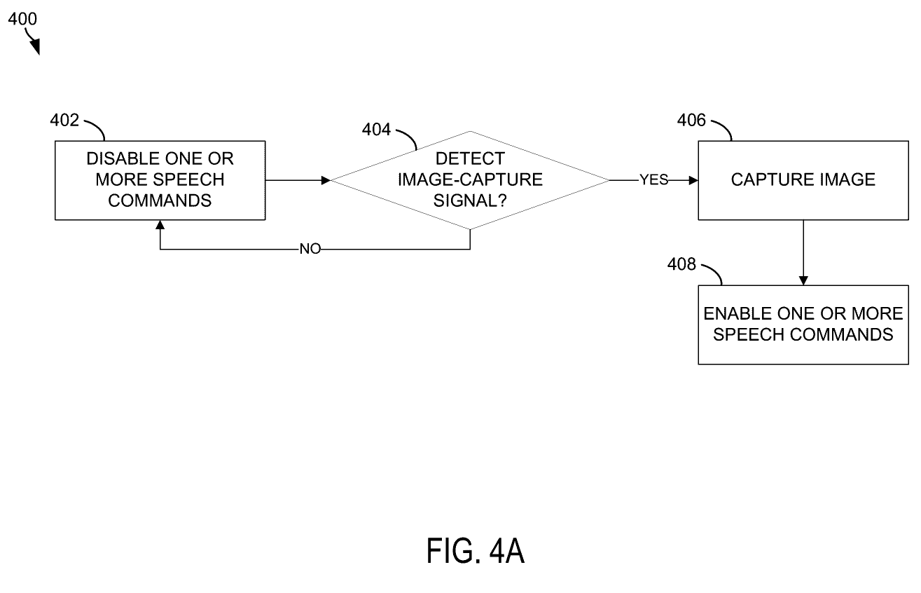

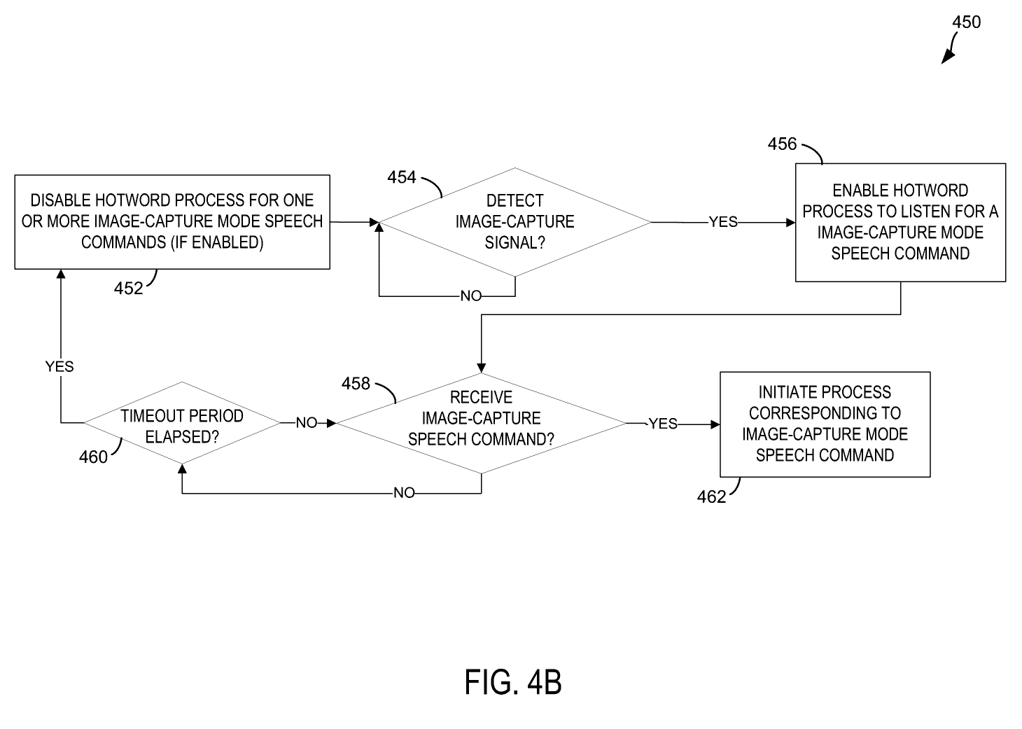

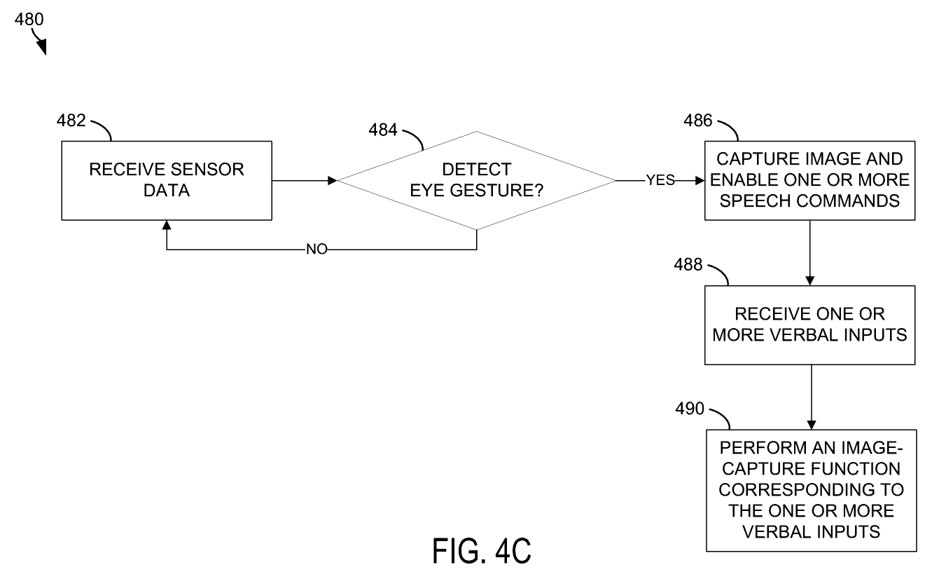

FIG. 4A depicts a flowchart of an example method 400. Method 400 may include one or more operations, functions, or actions as illustrated by one or more of blocks 402-408. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 400 and other processes and methods disclosed herein, the block diagram shows functionality and operation of one possible implementation of present embodiments. In this regard, each block may represent a module, a segment, or a portion of program code, which includes one or more instructions executable by a processor or computing device for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable medium may also be any other volatile or non-volatile storage systems. The computer readable medium may be considered a computer readable storage medium, for example, or a tangible storage device.

Referring again to FIG. 4A, method 400 involves a computing device, such as an HMD or component thereof. At block 402, the method includes initially disabling one or more speech commands. By disabling voice commands until such a guard phrase is detected, an HMD may be able to reduce the occurrence of false-positives. In other words, the HMD may be able to reduce instances where the HMD incorrectly interprets speech as including a particular speech command, and thus takes an undesired action.

The method 400 continues at block 404 with detecting an image-capture signal. Example image-capture signals will now be described in greater detail. It should be understood, however, that the described image-capture signals are not intended to be limiting.

In some embodiments, an HMD may allow for a wearer of the HMD to capture an image by winking, or carrying out some other kind of eye gesture. As such, the HMD may include one or more types of sensors to detect when the wearer winks and/or performs other eye gestures (e.g., a blink, a movement of the eye-ball, and/or a combination of such eye movements). For example, the HMD may include one or more inward-facing proximity sensors directed towards the eye, one or more inward-facing cameras directed towards the eye, one or more inward-facing light sources (e.g., infrared LEDs) directed towards the eye and one or more corresponding detectors, among other possible sensor configurations for an eye-tracking system (which may also be referred to as a “gaze-tracking system”).

In a wink-to-capture-an-image embodiment, the image-capture signal that is detected at block 404 may include or take the form of sensor data that corresponds to a closed eye. In particular, the HMD may analyze data from an eye-tracking system to detect data that is indicative of a wearer closing their eye. This may be interpreted as an indication that the wearer is in the process of winking to capture an image, as closing one's eye is an initial part of the larger action of winking.

In a wink-to-capture-an-image embodiment, the mage-capture signal, which is detected at block 404, may also include or take the form of sensor data that corresponds to fixation on a location in an environment of the computing device. In particular, there may be times when an HMD wearer stares at a subject before capturing an image of it. The wearer may do so in order to frame the image and/or while contemplating whether the subject is something they want to capture an image of, for example. Accordingly, the HMD may interpret eye-tracking data that indicates a wearer is fixating (e.g., staring) at a subject as being an indication that the user is about to or is likely to take an action, such as winking, to capture an image of the subject.

The HMD could also interpret data from one or more motion and/or positioning sensors as being indicative of the wearer fixating on a subject. For example, sensor data from sensors such as a gyroscope, an accelerometer, and/or a magnetometer may indicate motion and/or positioning of the HMD. An HMD may analyze data from such sensors to detect when the sensor data indicates that the HMD is undergoing motion (or substantial lack thereof) that is characteristic of the user staring at an object. Specifically, when an HMD is worn, a lack of movement by the HMD for at least a predetermined period of time may indicate that the HMD wearer is fixating on a subject in the wearer's environment. Accordingly, when such data is detected, the HMD may deem this to be an image-capture signal, and responsively capture an image.

Further, in some embodiments, image data from a point-of-view camera may be analyzed to help detect when the wearer is fixating on a subject. In particular, a forward-facing camera may be mounted on an HMD such that when the HMD is worn, the camera is generally aligned with the direction that the wearer's head is facing. Therefore, image data from the camera may be considered to be generally indicative of what the wearer is looking, and thus can be analyzed to help determine when the wearer is fixating on a subject.

Yet further, a combination of the techniques may be utilized to detect fixation by the wearer. For example, the HMD may analyze eye-tracking data, data from motion sensors, and/or data from a point-of-view camera to help detect when the wearer is fixating on a subject. Other examples are also possible.

As noted above, in some implementations, an HMD may only initiate the image-capture process when a certain combination of two or more image capture signals is detected. For example, an HMD that provides wink-to-capture-an-image functionality might initiate an image-capture process when it detects both (a) fixation on a subject by the wearer and (b) closure of the wearer's eye. Other examples are also possible.

As further noted above, an HMD may determine a probability of a subsequent image-capture signal, and only initiate the image-capture process when the probability of subsequent image capture is greater than a threshold. For example, the HMD could associate a certain probability with the detection of a particular image-capture signal or the detection of a certain combination of image-capture signals. Then, when the HMD detects such an image-capture signal or such a combination of image-capture signals, the HMD may determine the corresponding probability of a subsequent image capture. The HMD can then compare the determined probability to a predetermined threshold in order to determine whether or not to initiate the image-capture process.

As a specific example, an HMD that provides wink-to-capture-an-image functionality might determine that the probability of a subsequent image capture is equal to 5% when eye closure is detected. Similarly, the HMD could determine that the probability of a subsequent image capture is equal to 12% when fixation on a subject is detected. Further, the HMD might determine that the probability of a subsequent image capture is equal to 65% when fixation on a subject and an eye closure are both detected. The determined probability of a subsequent image capture could then be compared to a predetermined threshold (e.g., 40%) in order to determine whether or not to initiate the image-capture process.

In some embodiments, an HMD may allow a user to capture an image with an image-capture button. The image-capture button may be a physical button that is mechanically depressed and released, such as button 279 of HMD 272, shown in FIG. 2D. An HMD may also include a virtual image-capture button that is engaged by touching the user's finger to a certain location on a touchpad interface. In either case, the HMD may operate its camera to capture in image when the wearer presses down on or contacts the image-capture button, or upon release of the button.

In such an embodiment, the image-capture signal, which is detected at block 404, may also include or take the form of sensor data that is indicative of wearer's hand or finger interacting with the image-capture button. Thus, block 406 may involve the HMD initiating the image-capture process when it detects that the wearer's finger is interacting with the image-capture button. Accordingly, the HMD may include one or more sensors that are arranged to detect when a wearer's hand or finger is near to the image-capture button. For example, the HMD may include one or more proximity sensors and/or one or more cameras that are arranged to detect when a wearer's hand or finger is near to the image-capture button. Other sensors are also possible.

Other types of image-capture signals and/or combinations of image-capture signals are possible as well. For example, the image-capture signal may also include or take the form of sensor data that corresponds to fixation on a location in an environment of the computing device. Specifically, as described above, the HMD may interpret eye-tracking data, motion-sensor data, and/or image data that indicates a wearer is fixating on a subject as indicating that the user is about to or is likely to take an action to capture an image of the subject. Other examples are also possible.

Referring back to FIG. 4A, method 400 continues at block 406 with capturing an image in response to detecting the image-capture signal. The captured image may be stored in the memory of the HMD, or stored in another computing device. The image-capture device used to capture the image can be a camera, another photographic device, or any combination of hardware, firmware, and software that is configured to capture image data. The image-capture device can be disposed at the HMD or apart from the HMD. As an illustrative example, the image-capture device can be a forward-facing camera. As another illustrative example, the image-capture device can be a camera that is separate from the HMD and in communication with the HMD with the use of a wired or wireless connection. Note that any suitable camera or combination of cameras can serve as the image-capture device. Examples of suitable cameras include a digital camera, a video camera, a pinhole camera, a rangefinder camera, a plenoptic camera, a single-lens reflex camera, or combinations of these. These examples are merely illustrative; other types of cameras can be used.

The method 400 continues at block 408 with enabling one or more speech commands in response to capturing the image. The one or more speech commands may relate to the image-capture device and/or the image just captured by the image-capture device. To enable the one or more speech commands, an HMD may utilize “hotword” models. A hotword process may be program logic that is executed to listen for certain voice or speech commands in an incoming audio stream. Accordingly, when the HMD detects an image-capture signal and the image is captured, (e.g., at block 406), the HMD may responsively load a hotword process or models for the one or more speech commands (e.g., at block 408).

FIG. 4B is a flow chart illustrating another method 450, according to an example embodiment. Method 450 is an embodiment of method 400 in which one or more hotword processes are used to detect image-capture mode speech commands. Further, in method 450 a time-out process is added as an additional protection against false-positive detections of speech commands.

Referring to FIG. 4B in greater detail, the HMD disables the hotword process for one or more image-capture mode speech commands (if it is enabled at the time), as shown by block 452. The HMD then detects an image-capture signal in block 454. This step may be similar to the embodiments discussed above in relation to block 404 of method 400. If an image-capture signal is detected, the HMD enables the hotword process for one or more image-capture mode speech commands, as shown by block 456. The hotword process for the one or more image-capture mode speech commands is then used to listen for these speech commands, as shown by block 458.

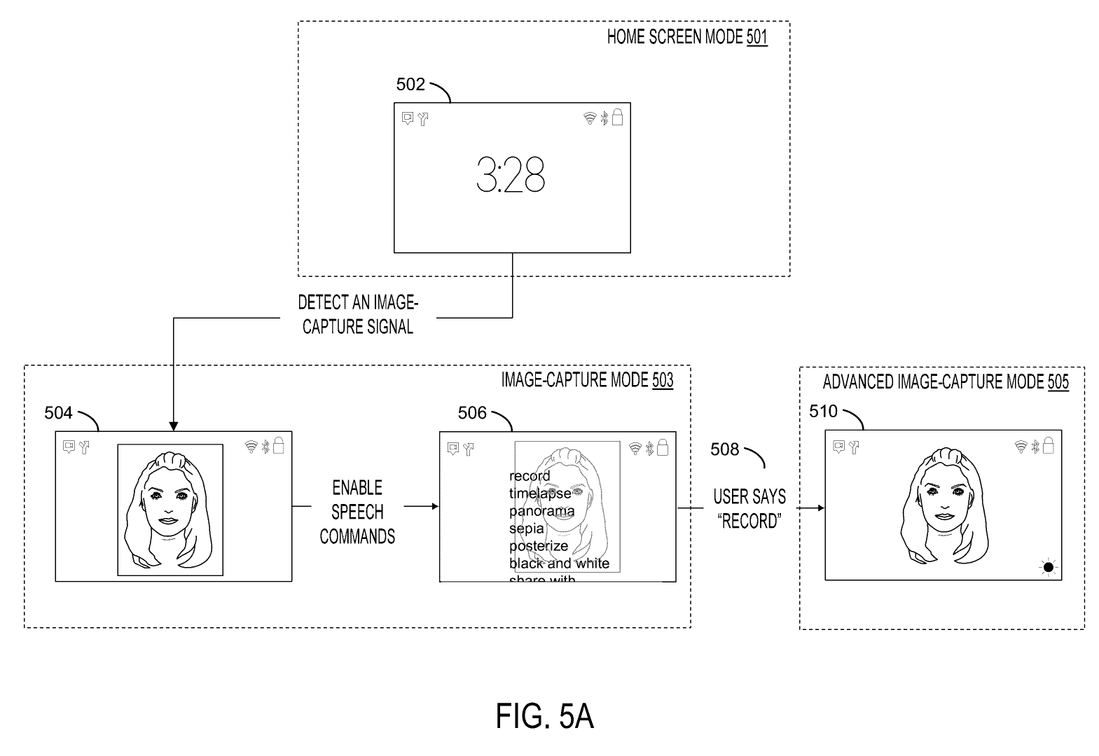

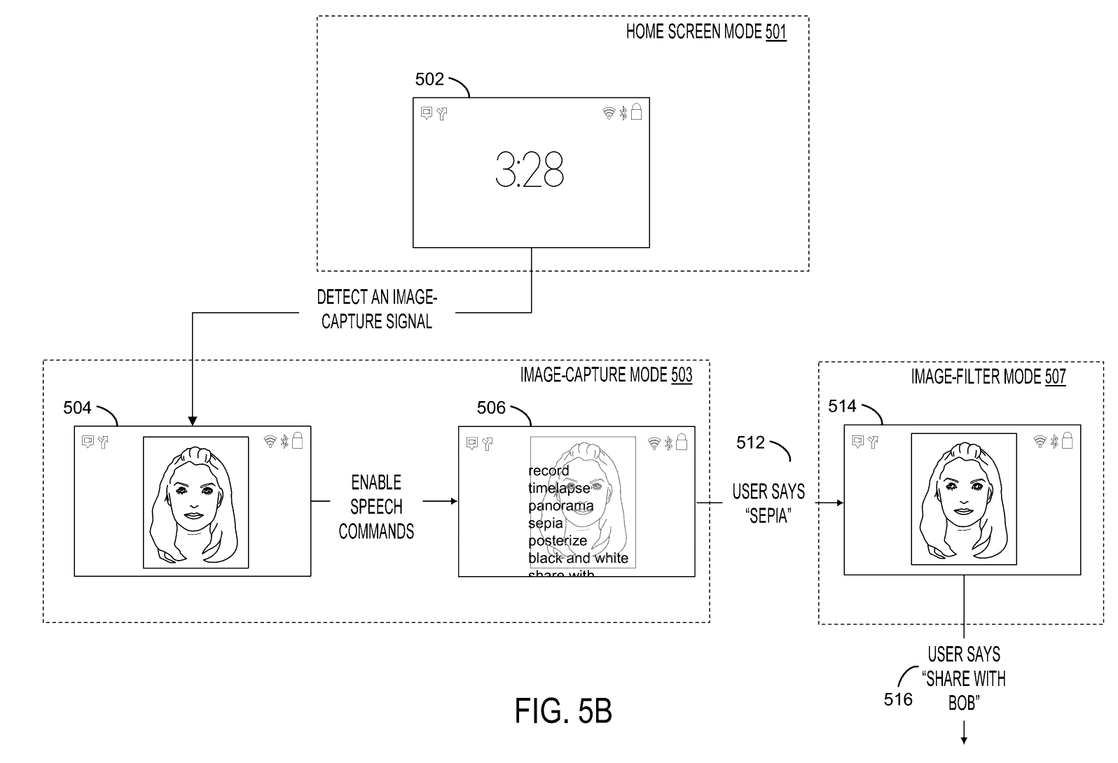

In the illustrated embodiment, the image-capture mode speech commands include one speech command that launches a process and/or UI that corresponds to the image-capture device and/or image captured by the image-capture device. The image-capture mode speech commands are discussed in greater detail below in relation to FIGS. 5A and 5B.

In a further aspect, when the HMD detects the image-capture signal, the HMD may also implement a time-out process. For example, at or near when the HMD detects the image-capture signal, the HMD may start a timer. Accordingly, the HMD may then continue to listen for the image-capture mode speech command, at block 458, for the duration of the timer (which may also be referred to as the “timeout period”). If the HMD detects the image-capture mode speech command before the timeout period elapses, the HMD initiates a process corresponding to the second-mode speech command, as shown by block 462. However, if the image-capture mode speech command has not been detected, and the HMD determines at block 460 that the timeout period has elapsed, then the HMD repeats block 452 in order to disable the hotword process for the image-capture mode speech command.

In a further aspect, an HMD may also provide visual cues for a voice UI. As such, when the hotword process is enabled, such as at block 456, method 450 may further include the HMD displaying a visual cue that is indicative of the image-capture mode speech commands. For example, at block 456, the HMD may display visual cues that correspond to the image-capture mode speech commands. Other examples are also possible.

FIG. 4C is a flow chart illustrating yet another method 480, according to an example embodiment. Method 480 is an embodiment in which the HMD detects an eye gesture, and concurrently captures an image and enables one or more speech commands. The one or more speech commands may relate to the image-capture device and/or the image just captured by the image-capture device.

Referring to FIG. 4C in greater detail, the method 480 begins at block 482 by receiving sensor data from one or more sensors on the HMD. As discussed above, the HMD may include one or more types of sensors to detect when the wearer winks and/or performs other eye gestures (e.g., a blink, a movement of the eye-ball, and/or a combination of such eye movements). At block 484, the HMD may use these sensors to detect an eye gesture. If no eye gesture is detected, the method begins again at block 482 with the HMD receiving sensor data to detect one or more eye gestures. If the HMD detects an eye gesture, the HMD may be configured to simultaneously take a photo and enable one or more speech commands relating to the image-capture device, as shown in block 486. While the one or more speech commands are enabled, the HMD may receive one or more verbal inputs corresponding to the one or more enabled speech commands, as shown in block 488. The method 480 continues at block 490 with performing an image-capture function corresponding to the one or more verbal inputs.

The ability to wink to capture an image using an HMD is a simple yet powerful function. When enabling imaging-related speech commands with a wink, it may be desirable to keep the functionality of the ability to wink to capture an image. By simultaneously capturing an image and enabling the speech commands, the functionality of wink to take a photo is not lost. Specific applications of the wink to capture an image functionality will now be discussed.

The HMD may detect a wink, and responsively capture an image using a point-of-view camera located on the HMD. The HMD may also enable one or more speech commands related to the point-of-view camera. For example, the HMD may listen for the speech command “Record” to record a video. In one example, the HMD may delete the photo captured with the wink when a video recording begins. In another example, the HMD may use the photo captured with the wink as a thumbnail for the video recording, or otherwise associate the photo with the video recording. In yet another example, the HMD may listen for the voice command “Time-lapse”to capture multiple sets of image data at spaced time intervals. Further, the HMD may listen for the voice command “Panorama” to record a panorama where the user turns around and captures a 360-degree image. The HMD may discard or similarly associate the photo captured with the wink when the “Time-lapse” and “Panorama” commands are received. Other example image-capture functions are possible as well.

In another embodiment, the HMD may detect a wink, take a photo using a point-of-view camera on the HMD, and enable one or more speech commands related to the photo just taken. For example, the speech commands may include various image processing filter commands, such as “Black and White,” “Posterize,” and “Sepia” as examples. Such commands may apply an image filter to or otherwise process the photo taken by the point-of-view camera on the HMD in response to the detection of a wink. For example, a user may wink to take a photo, and speak the command “Sepia” to apply a sepia filter to the photo just taken. The filtered image may then be displayed on a screen of the HMD.

Additionally, the HMD may listen for a sharing command, such as “Share with X” which could be used to share the captured image with a contact (“X”) via a communication link. In one example, the image may be shared via text-message or e-mail. In another example, the image may be shared via a social networking website. In one example, a filter may be applied to the image before sharing. In other examples, a user may simply capture an image by winking, and share the raw image with a contact via a communication link using the voice command “Share with X”.

### IV. ILLUSTRATIVE DEVICE FUNCTIONALITY

FIGS. 5A and 5B illustrate applications of a UI in an image-capture mode, according to example embodiments. In order to provide a voice-enabled UI in an image-capture mode, these applications may utilize methods such as those described in reference to FIGS. 4A and 4B. However, other techniques may also be used to provide the UI functionality shown in FIGS. 5A and 5B.

FIG. 5A shows an application that involves a home-screen mode 501, an image-capture mode 503, and an advanced image-capture mode 505. The home screen 502 may include a time, a battery life indication, and other basic indicators and may serve as a starting point for various applications of the HMD. An HMD may operate in a home-screen mode 501, where certain image-capture signals may be detected. In one example, the image-capture signal may include sensor data that is indicative of an eye gesture, such as a wink. In another example, the image-capture signal may include sensor data that is indicative of an interaction with a button interface. Other examples are possible as well.

Once the HMD detects an image-capture signal, the HMD may enter an image-capture mode 503. In the image-capture mode, the HMD may be configured to capture an image 504, and responsively enable speech commands. When the HMD enables speech commands, the HMD may continuously listen for speech, so that a user can readily use the speech commands to interact with the HMD. These speech commands may relate to photography, or more generally to the image-capture device of the HMD. By disabling these image-capture mode voice commands until the image-capture signal is detected, an HMD may reduce the occurrence of false-positives. In other words, the HMD may reduce instances where the HMD incorrectly interprets speech as including a particular speech command, and thus takes an undesired action. In one embodiment, when the HMD detects the image-capture signal, a speech recognition system may be optimized to recognize a small set of words and/or phrases. In one example, this may include a photo-related “hotword” model that may be loaded into the HMD. The photo-related “hotword” model may be configured to listen for a subset of speech commands that are specific to photography and/or image-capture device settings.

In one example, when the HMD enables speech commands, the HMD may display a visual cue that is indicative of the image-capture mode speech commands, as shown in screen view 506. In one example, a user may scroll through the menu of speech commands by looking up or down. In another example, a user may use a touchpad on the HMD to scroll through the menu of speech commands. Other embodiments are possible as well.

If the HMD detects an image-capture signal and an image is captured, the HMD may load a photo-related “hotword” model and listen for certain voice commands. For example, the HMD may listen for the voice command “Record” to record a video. In another example, the HMD may listen for the voice command “Time-lapse” to capture an image every M seconds. Further, the HMD may listen for the voice command “Panorama” to record a panorama where the user turns around and captures a 360-degree image. Other example image-capture functions are possible as well. In one example, the image-capture functions may be turned off with an eye gesture, such as a wink. In another example, the image-capture functions may be turned off with an eye gesture, followed by the voice command “Stop.” Other examples are possible as well.

Referring back to FIG. 5A, the user speaks the command “Record” 508 when the speech commands are enabled. The HMD may then switch to an advanced image-capture mode 505. The advanced image-capture mode 505 may include such functions as video recording, time-lapse photography, and panorama photography, as examples. In response to the “Record” command, the HMD responsively begins to record a video with the image-capture device, as shown in screen view 510. Also shown in screen view 510 is an indicator in the lower right that may blink to indicate that video is being captured. In one example, the image captured 504 in response to the detected image-capture signal may be deleted when a video recording begins. In another example, the image captured 504 in response to the detected image-capture signal may be used as a thumbnail for the video recording.

As noted above, the image-capture mode may also include a timeout process to disable speech command(s) when no speech command is detected within a certain period of time after detecting the image-capture signal.

Other image-capture related speech commands are possible as well. For example, FIG. 5B shows an application that involves an image-capture mode 503 and an image-filter mode 507. The image-filter mode 507 may include other speech commands that may be applied to “the photo just taken”. In one example, the speech commands may include various image processing filter commands, such as “Black and White,” “Posterize,” and “Sepia” as examples. Such commands would apply an image filter to the image just captured by the image-capture device in response to the image-capture signal. For example, an image-capture signal may be detected, and the image-capture device responsively captures an image, as shown in screen view 504. In response to image being captured, the HMD may enable speech commands and may display the potential commands as shown in screen view 506. The user may speak the command “Sepia” 512 to apply a sepia filter to the image just captured. The filtered image may be displayed, as shown in screen view 514.

Additionally, the HMD may listen for a sharing command, such as “Share with Bob” 516 which could be used to share the captured image with any contact via a communication link. In one example, the image may be shared via text-message or e-mail. In another example, the image may be shared via a social networking website. In the example in FIG. 5B, a filter has been applied to the image before sharing. In other examples, a user may simply capture an image through an image-capture signal, and share the raw image with a contact via a communication link.

One specific example of this process includes an HMD configured to allow a wearer of the HMD to capture an image by winking. In such a case, one potential flow for this process may include: Wink+“Black and White”+“Share with Bob”. In this case, the HMD would capture an image, apply a black and white filter to the image, and share the image with Bob. Another potential flow for this process may include: Wink+“Share with Bob”. In this case, the HMD would capture and image and share the raw image with Bob. Other examples are possible as well.

### V. EXAMPLE COMPUTER-READABLE MEDIUM CONFIGURED TO ENABLE SPEECH COMMANDS BASED ON DETECTION OF AN IMAGE-CAPTURE SIGNAL

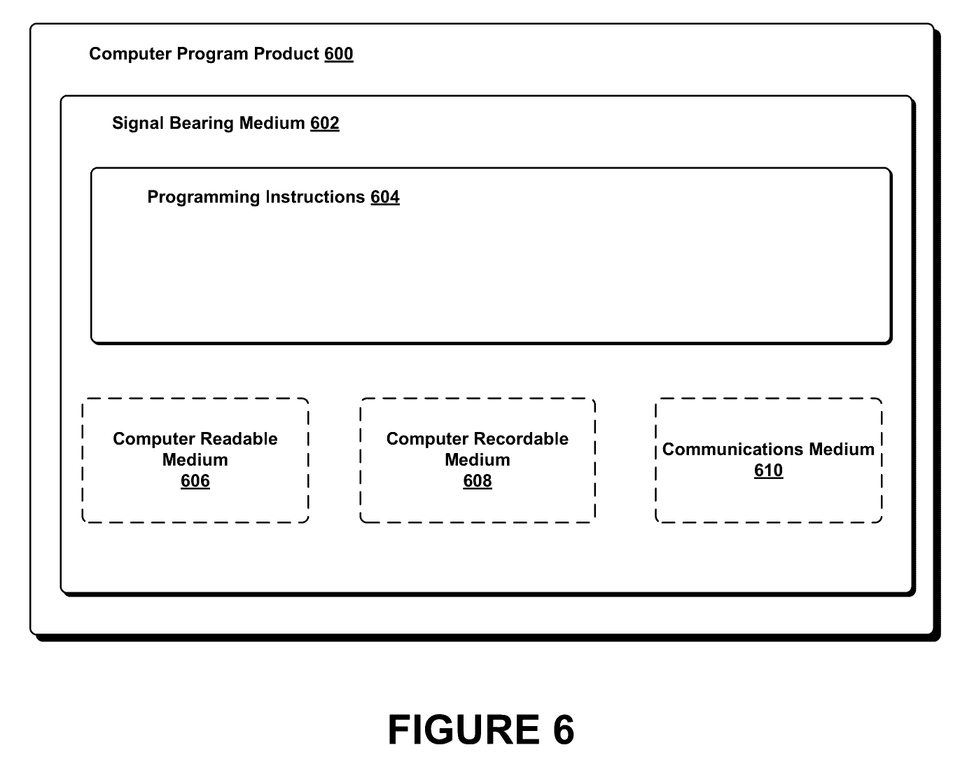

FIG. 6 depicts a computer-readable medium configured according to an example embodiment. In example embodiments, the example system can include one or more processors, one or more forms of memory, one or more input devices/interfaces, one or more output devices/interfaces, and machine-readable instructions that when executed by the one or more processors cause the system to carry out the various functions, tasks, capabilities, etc., described above.

As noted above, in some embodiments, the disclosed methods can be implemented by computer program instructions encoded on a non-transitory computer-readable storage media in a machine-readable format, or on other non-transitory media or articles of manufacture. FIG. 6 is a schematic illustrating a conceptual partial view of an example computer program product that includes a computer program for executing a computer process on a computing device, arranged according to at least some embodiments presented herein.

In one embodiment, the example computer program product 600 is provided using a signal bearing medium 602. The signal bearing medium 602 may include one or more programming instructions 604 that, when executed by one or more processors may provide functionality or portions of the functionality described above with respect to FIGS. 1-5B. In some examples, the signal bearing medium 602 can be a computer-readable medium 606, such as, but not limited to, a hard disk drive, a Compact Disc (CD), a Digital Video Disk (DVD), a digital tape, memory, etc. In some implementations, the signal bearing medium 602 can be a computer recordable medium 608, such as, but not limited to, memory, read/write (R/W) CDs, R/W DVDs, etc. In some implementations, the signal bearing medium 602 can be a communications medium 610, such as, but not limited to, a digital and/or an analog communication medium (e.g., a fiber optic cable, a waveguide, a wired communications link, a wireless communication link, etc.). Thus, for example, the signal bearing medium 602 can be conveyed by a wireless form of the communications medium 610.

The one or more programming instructions 604 can be, for example, computer executable and/or logic implemented instructions. In some examples, a computing device such as the processor 314 of FIG. 3 is configured to provide various operations, functions, or actions in response to the programming instructions 604 conveyed to the processor 314 by one or more of the computer-readable medium 606, the computer recordable medium 608, and/or the communications medium 610.

The non-transitory computer-readable medium could also be distributed among multiple data storage elements, which could be remotely located from each other. The device that executes some or all of the stored instructions could be a client-side computing device 310 as illustrated in FIG. 3. Alternatively, the device that executes some or all of the stored instructions could be a server-side computing device.

### VI. CONCLUSION

It should be understood that arrangements described herein are for purposes of example only. As such, those skilled in the art will appreciate that other arrangements and other elements (e.g., machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

Where example embodiments involve information related to a person or a device of a person, some embodiments may include privacy controls. Such privacy controls may include, at least, anonymization of device identifiers, transparency and user controls, including functionality that would enable users to modify or delete information relating to the user's use of a product.

Further, in situations in where embodiments discussed herein collect personal information about users, or may make use of personal information, the users may be provided with an opportunity to control whether programs or features collect user information (e.g., information about a user's medical history, social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

1. A computing device comprising:
an image-capture device;
a display; and
a control system configured to:
receive sensor data from one or more sensors;
analyze the sensor data to detect at least one image-capture signal;
in response to detection of the at least one image-capture signal, cause the image-capture device to capture an image;
in response to capturing the image, (a) display the captured image on the display, (b) enable, for a predetermined period of time, one or more speech commands relating to the image-capture device, and (c) display, for the predetermined period of time, one or more textual visual cues indicative of at least one of the one or more enabled speech commands on the display, wherein the one or more textual visual cues are displayed at least partially over the captured image on the display;
receive one or more verbal inputs corresponding to the one or more enabled speech commands;
perform an image-capture function corresponding to the one or more verbal inputs; and
if the predetermined period of time elapses without receipt of at least one of the one or more verbal inputs corresponding to the one or more enabled speech commands, both (a) disable the one or more speech commands, and (b) remove the one or more textual visual cues from the display while still displaying the captured image on the display.

2. The computing device of claim 1, wherein the computing device is implemented as part of or takes the form of a head-mountable device (HMD).

3. The computing device of claim 1, wherein the one or more sensors comprise one or more of: (a) one or more proximity sensors, (b) one or more button interfaces, (c) one or more microphones, (d) one or more accelerometers, (e) one or more gyroscopes, and (f) one or more magnetometers.

4. The computing device of claim 1, wherein the at least one image-capture signal comprises sensor data that is indicative of an eye gesture.

5. The computing device of claim 1, wherein the at least one image-capture signal comprises sensor data that is indicative of an interaction with a button interface.

6. The computing device of claim 1, wherein the one or more speech commands comprise one or more phrases indicative of an image processing filter, and wherein the control system is further configured to apply the image processing filter to the captured image.

7. The computing device of claim 1, wherein the one or more speech commands comprise one or more phrases indicative of sharing the captured image via a communication link.

8. The computing device of claim 1, wherein the one or more speech commands comprise one or more phrases indicative of recording a video.

9. The computing device of claim 8, wherein the control system is further configured to:
delete the captured image when the control system receives one or more verbal inputs indicative of recording a video.

10. The computing device of claim 8, wherein the control system is further configured to:
use the captured image as a thumbnail for a recorded video.

11. (canceled)

12. The computing device of claim 1, wherein the control system enables the one or more speech commands by loading a hotword process configured to listen for the one or more verbal inputs corresponding to the one or more enabled speech commands.

13. A computer implemented method comprising:
receiving sensor data from one or more sensors associated with a computing device, wherein the computing device includes an image-capture device and a display;
analyzing the sensor data to detect at least one image-capture signal;
in response to detection of the at least one image-capture signal, causing the image-capture device to capture an image;
in response to capturing the image, (a) displaying the captured image on the display, (b) enabling, for a predetermined period of time, one or more speech commands relating to the image-capture device, and (c) displaying, for the predetermined period of time, one or more textual visual cues indicative of at least one of the one or more enabled speech commands on the display, wherein the one or more textual visual cues are displayed at least partially over the captured image on the display;
receiving one or more verbal inputs corresponding to the one or more enabled speech commands;
performing an image-capture function corresponding to the one or more verbal inputs; and
if the predetermined period of time elapses without receipt of at least one of the one or more verbal inputs corresponding to the one or more enabled speech commands, both (a) disabling the one or more speech commands, and (b) removing the one or more textual visual cues from the display while still displaying the captured image on the display.

14. (canceled)

15. The method of claim 13, wherein enabling the one or more speech commands comprises loading a hotword process configured to listen for the one or more verbal inputs corresponding to the one or more enabled speech commands.

16. A non-transitory computer readable medium having stored therein instructions executable by a computing device to cause the computing device to perform functions comprising:
receiving sensor data from one or more sensors associated with a computing device, wherein the computing device includes an image-capture device and a display;
analyzing the sensor data to detect at least one image-capture signal;
in response to detection of the at least one image-capture signal, causing the image-capture device to capture an image;
in response to capturing the image, (a) displaying the captured image on the display, (b) enabling, for a predetermined period of time, one or more speech commands relating to the image-capture device, and (c) displaying, for the predetermined period of time, one or more textual visual cues indicative of at least one of the one or more enabled speech commands on the display, wherein the one or more textual visual cues are displayed at least partially over the captured image on the display;
receiving one or more verbal inputs corresponding to the one or more enabled speech commands;
performing an image-capture function corresponding to the one or more verbal inputs; and
if the predetermined period of time elapses without receipt of at least one of the one or more verbal inputs corresponding to the one or more enabled speech commands, both (a) disabling the one or more speech commands, and (b) removing the one or more textual visual cues from the display while still displaying the captured image on the display.

17. (canceled)

18. The non-transitory computer readable medium of claim 16, wherein enabling the one or more speech commands comprises loading a hotword process configured to listen for the one or more verbal inputs corresponding to the one or more enabled speech commands.

19. A computer implemented method comprising:
receiving sensor data from one or more sensors associated with a computing device, wherein the computing device includes an image-capture device and a display;
analyzing the sensor data to detect at least one eye gesture;
in response to capturing the image, (a) displaying the captured image on the display, (b) enabling, for a predetermined period of time, one or more speech commands relating to the image-capture device, and (c) displaying, for the predetermined period of time, one or more textual visual cues indicative of at least one of the one or more enabled speech commands on the display, wherein the one or more textual visual cues are displayed at least partially over the captured image on the display;
while the one or more speech commands are enabled, receiving one or more verbal inputs corresponding to the one or more enabled speech commands;
performing an image-capture function corresponding to the one or more verbal inputs; and
if the predetermined period of time elapses without receipt of at least one of the one or more verbal inputs corresponding to the one or more enabled speech commands, both (a) disabling the one or more speech commands, and (b) removing the one or more textual visual cues from the display while still displaying the captured image on the display.

20. The method of claim 19, wherein the eye gesture comprises sensor data indicative of a wink.

21.-25. (canceled)
